(19) United States
(12) Patent Application Publication
(10) Pub. No.: US 2013/0271070 A1
(43) Pub. Date: Oct. 17, 2013

(54) HOLDER AND WIRELESS CHARGING DEVICE INCLUDING HOLDER

(71) Applicant: KABUSHIKI KAISHA TOKAI RIKA DENKI SEISAKUSHO, Aichi (JP)

(72) Inventor: Yoshihisa HIRANO, Aichi (JP)

(73) Assignee: KABUSHIKI KAISHA TOKAI RIKA DENKI SEISAKUSHO, Aichi (JP)

(21) Appl. No.: 13/854,394

(22) Filed: Apr. 1, 2013

(30) Foreign Application Priority Data
Apr. 12, 2012 (JP) 2012-091164

(51) Int. Cl. H02J 7/00; H02J 7/02

(52) U.S. Cl. CPC H02J 7/0044; H02J 7/025
USPC 320/108; 206/703

(57) ABSTRACT

A holder for holding a charged device. The charged device includes a secondary coil that induces power based on a change in magnetic flux from a primary coil. The holder includes a case that accommodates the primary coil. Movable portions are movably held by the case. The movable portions are movable relative to the case. Each of the movable portions includes a first end located in the case and a second end located outside the case. A holding portion is formed on the second end of each movable portion. The holding portions contact side surfaces of the charged device to surround and hold the charged device.

### CROSS-REFERENCE TO RELATED APPLICATIONS

This application is based upon and claims the benefit of priority from prior Japanese Patent Application No. 2012-091164, filed on Apr. 12, 2012, the entire contents of which are incorporated herein by reference.

### BACKGROUND ART

The present invention relates to a holder that holds a charged device and to a wireless charging device that includes a holder.

Japanese Laid-Open Patent Publication No. 2008-5573 describes an example of a wireless charging system that charges a charged device by transmitting power in a wireless manner from a wireless charging device to the charged device. More specifically, a power transmission pad is formed on an upper side surface of the wireless charging device. The charged device is set on the power transmission pad. The wireless charging device includes a primary coil arranged at a location corresponding to the transmission pad. The charged device includes a secondary coil. When the primary coil is excited, a change in the magnetic flux of the excited primary coil induces power at the secondary coil of the charged device that is arranged on the power transmission pad. The power is used to charge a battery that is incorporated in the charged device.

When a wireless charging device is installed, for example, in a vehicle and the vehicle is travelling, inertial force may be applied to a charged device that is set on the power transmission pad. To prevent the charged device from falling off the transmission pad when inertial force is applied, a holder may be used to hold and support the sides of the charged device.

However, the charged device may be any one of a variety of products. Thus, the location of the secondary coil in the charged device would differ between different products. As a result, when the holder holds the charged device, the location of the secondary coil in the charged device may not necessarily correspond to the location of the primary coil in the wireless charging device. When the secondary coil is arranged coaxially with the primary coil, power is transmitted with maximum efficiency from the primary coil to the secondary coil. In contrast, the power transmission efficiency is decreased when the secondary coil of the charged device is located at a position that does not correspond to the primary coil of the wireless charging device.

### SUMMARY OF THE INVENTION

One aspect of the present invention is a holder for holding a charged device. The charged device includes a secondary coil that induces power based on a change in magnetic flux from a primary coil. The holder includes a case that accommodates the primary coil. A plurality of movable portions are movably held by the case. The movable portions are movable relative to the case, and each of the movable portions includes a first end located in the case and a second end located outside the case. The holder further includes a plurality of holding portions, each formed on the second end of each of the movable portions. The holding portions contact side surfaces of the charged device to surround and hold the charged device.

A further aspect of the present invention is a wireless charging device for charging a charged device including a secondary coil. The wireless charging device includes an excitation circuit, a primary coil that forms magnetic flux when excited by current from the excitation circuit to induce power at the secondary coil, and a holder that holds the charged device. The holder includes a case that accommodates the primary coil. A plurality of movable portions are movably held by the case. The movable portions are movable relative to the case, and each of the movable portions includes a first end located in the case and a second end located outside the case. The holder further includes a plurality of holding portions, each formed on the second end of each of the movable portions. The holding portions contact side surfaces of the charged device to surround and hold the charged device.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic block diagram showing a wireless charge system according to one embodiment of the present invention;

FIG. 2A is a schematic cross-sectional view taken along line B-B in FIG. 2B;

FIG. 2B is a schematic cross-sectional view taken along line A-A in FIG. 2A;

FIG. 2C is a partially enlarged view of the holder shown in FIG. 2A;

FIG. 3A is a schematic cross-sectional view of the holder when the primary coil is separated from the secondary coil;

FIG. 3B is a schematic cross-sectional view of the holder when the primary coil is positioned in correspondence with the secondary coil.

### DETAILED DESCRIPTION OF THE INVENTION

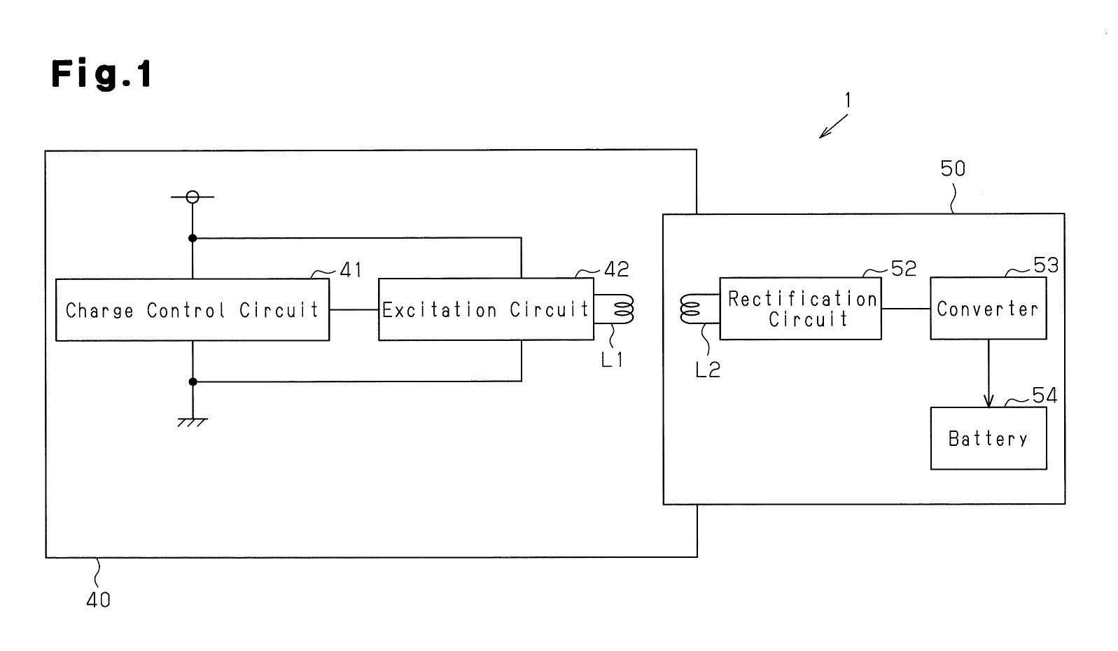

An in-vehicle wireless charge system including a holder according to one embodiment of the present invention will now be described with reference to FIGS. 1 to 3.

As shown in FIG. 1, the in-vehicle wireless charging system 1 includes a wireless charging device 40 and a portable terminal 50.

The wireless charging device 40 includes a charge controller 41, an excitation circuit 42, and a primary coil L1. In this example, the wireless charging device 40 is of a single-coil type and includes a single primary coil L1.

The primary coil L1, which is a circular spiral coil, is connected to the excitation circuit 42. The charge controller 41 and the excitation circuit 42 are each connected between a power supply and ground. The charge controller 41 supplies the primary coil L1 with alternating current, which is generated by the excitation circuit. This excites the primary coil L1 and forms a magnetic flux that changes as time elapses.

The portable terminal 50 includes a secondary coil L2, a rectification circuit 52, a converter 53, and a battery 54.

When the magnetic flux from the primary coil L1 changes, the secondary coil L2 induces current (electromagnetic induction). The rectification circuit 52 converts the induced alternating current to direct current, and supplies the converted current to the converter 53. The converter 53 decreases or increases power, and supplies the power to the battery 54. This charges the battery 54. The portable terminal 50 corresponds to a charged device.

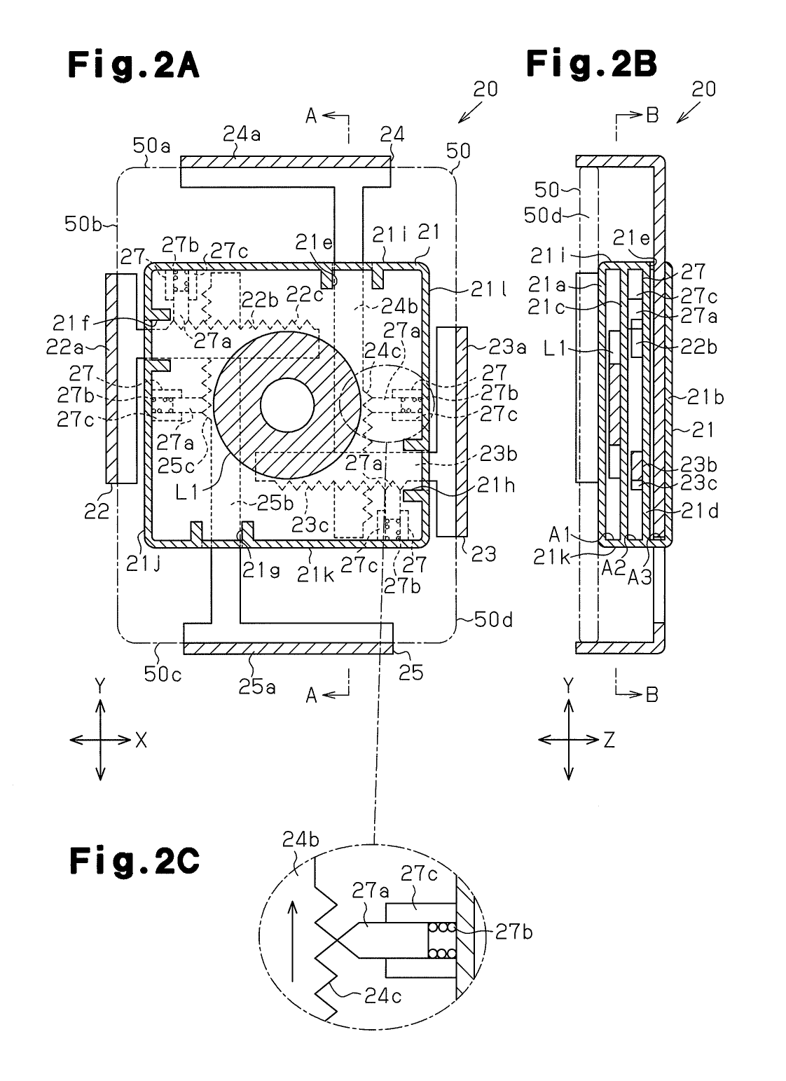

As shown in FIGS. 2A and 2B, the wireless charging device 40 includes a holder 20 that holds the portable terminal 50. The holder 20 holds the portable terminal 50 on the wireless charging device 40 so that the portable terminal 50 does not fall from the wireless charging device 40 when the vehicle is travelling and inertial force and centrifugal force is applied to the portable terminal 50. Further, the running engine or road surface may vibrate the portable terminal 50. In such cases, the holder 20 prevents the portable terminal 50 from falling off from the wireless charging device 40. In FIG. 2A, the left-to-right (lateral) direction of the plane of the drawing is defined as the X-axis direction, and the up-to-down (longitudinal) direction of the plane of the drawing is defined as the Y-axis direction. The direction orthogonal to the plane of the drawings is defined as the Z-axis direction. In FIG. 2B, the Z-axis direction is the lateral direction of the plane of the drawing.

In this example, the portable terminal 50, which is shown by single-dashed lines in FIG. 2A, has the form of a rectangular plate and includes four side surfaces 50a to 50d. The upper side surface 50a and the lower side surface 50c are parallel to each other. The left side surface 50b and the right side surface 50d are parallel to each other and orthogonal to the upper side surface 50a and the lower side surface 50c.

The holder 20 includes a case 21, two X-axis movable members 22 and 23, two Y-axis movable members 24 and 25, and four stoppers 27.

Referring to FIG. 2B, the case 21, which is a rectangular parallelepiped, includes a front plate 21a, which is located at the upper side in the Z-axis direction (left side of the plane of the drawing), a rear plate 21b, which is located at the lower side in the Z-axis direction (right side of the plane of the drawing), an upper side wall 21i, a left side wall 21j, a lower side wall 21k, and a right side wall 21l. The front plate 21a and the rear plate 21b each have a surface extending in the X-axis direction and the Y-axis direction. Inner walls 21c and 21d, which extend in the X-axis direction and the Y-axis direction, partition the interior void of the case 21. More specifically, the interior void of the case 21 is partitioned into a first void A1, which is formed between the front plate 21a and the inner wall 21c, a second void A2, which is formed between the two inner walls 21c and 21d, and a third void A3, which is formed between the inner wall 21d and the rear plate 21b.

The primary coil L1 is arranged in the first void A1. As shown in FIG. 2A, the primary coil L1 is located at the central portion of the case 21. The side walls 21i to 21l of the case 21 respectively include through holes 21e to 21h. The upper side wall 21i and the lower side wall 21k of the case extend in the X-axis direction, and the right side wall 21l and the left side wall 21j extend in the Y-axis direction.

As shown in FIG. 2A, a through hole 21e extends through the upper side wall 21i near the right side wall 21l and is in communication with the third void A3. A through hole 21f extends through the left side wall 21j near the upper side wall 21i and is in communication with the second void A2. A through hole 21g extends through the lower side wall 21k near the left side wall 21j and is in communication with the third void A3. A through hole 21h extends through the right side wall 21l near the lower side wall 21k and is in communication with the second void A2.

The movable member 22 includes a holding portion 22a and an insertion portion 22b. The movable member 23 includes a holding portion 23a and an insertion portion 23b. The movable member 24 includes a holding portion 24a and an insertion portion 24b. The movable member 25 includes a holding portion 25a and an insertion portion 25b. The holding portions 22a to 25a are formed integrally with the insertion portions 22b to 25b. The insertion portions 22b to 25b each correspond to a movable portion and each have the form of a polygonal rod with a rectangular cross-section. The insertion portion 22b of the X-axis movable member 22 is inserted through the through hole 21f, and the insertion portion 23b of the X-axis movable member 23 is inserted through the through hole 21h. The insertion portion 24b of the Y-axis movable member 24 is inserted through the through hole 21e, and the insertion portion 25b of the Y-axis movable member 25 is inserted through the through hole 21g. Each of the insertion portions 22b to 25b includes a first end located in the case 21 and a second end located outside the case 21, and is movably held by the case 21.

The holding portions 22a to 25a are respectively formed on the second ends of the insertion portions 22b to 25b outside the case 21. The holding portion 22a is L-shaped and partially covers the side surface 50b and the rear surface of the portable terminal 50. The holding portion 23a is L-shaped and partially covers the side surface 50d and the rear surface of the portable terminal 50. The holding portion 24a is L-shaped and partially covers the side surface 50a and the rear surface of the portable terminal 50. The holding portion 25a is L-shaped and partially covers the side surface 50c and the rear surface of the portable terminal 50.

The insertion portions 22b to 25b include serrations defining stopped portions 22c to 25c. In detail, the stopped portion 22c is formed on a side surface of the insertion portion 22b faced toward the upper side wall 21i. The stopped portion 23c is formed on a side surface of the insertion portion 23b faced toward the lower side wall 21k. The stopped portion 24c is formed on a side surface of the insertion portion 24b faced toward the right side wall 21l. The stopped portion 25c is formed on a side surface of the insertion portion 25b faced toward the left side wall 21j.

A stopper 27 that stops movement of the movable member 22 is arranged in the case 21, faced toward the stopped portion 22c, on an inner surface of the side wall 21i. A stopper 27 that stops movement of the movable member 25 is arranged in the case 21, faced toward the stopped portion 25c, on an inner surface of the side wall 21j. A stopper 27 that stops movement of the movable member 23 is arranged in the case 21, faced toward the stopped portion 23c, on an inner surface of the side wall 21k. A stopper 27 that stops movement of the movable member 24 is arranged in the case 21, faced toward the stopped portion 24c, on an inner surface of the side wall 21l.

Each stopper 27 includes a stopping piece 27a, a spring 27b, and a receptacle 27c. The receptacle 27c is tubular and accommodates a coil spring 27b and a stopping piece 27a, which are sequentially arranged from the corresponding one of the side walls 21i to 21l. The stopping piece 27a includes a distal end fitted to a valley in the corresponding one of the stopped portions 22c to 25c. The distal end of the stopping piece 27a is shaped in conformance with valleys in the stopped portions 22c to 25c. When the stopping piece 27a is fitted into a valley of the corresponding one of the stopped portions 22c to 25c, further movement of the corresponding one of the movable members 22 to 25 is restricted.

The operation of the holder 20 will now be described with reference to FIGS. 2A to 2C.

A user moves the movable members 22 to 25 relative to the case 21 until conforming to the size of the portable terminal 50. For example, when the distance between the Y-axis holding portions 24a and 25a is shorter than the length of the portable terminal 50, the user applies force to the Y-axis holding members to move the Y-axis holding portions 24a and 25a away from each other.

The user may, for example, apply force that is greater than or equal to a predetermined value to the Y-axis holding portion 24a in order to move the Y-axis holding portion 24a away from the case 21 in the Y-axis direction. As shown in FIG. 2C, this moves the distal end of the stopping piece 27a from a valley to a ridge of the stopped portion 24c, and the stopping piece 27a compresses the spring 27b. Then, as the distal end of the stopping piece 27a moves away from the ridge of the stopped portion, the resilient force of the spring 27b fits the stopping piece 27a into the next valley. In this manner, the Y-axis movable member 24 is moved by a force having a predetermined value or greater. When moving the Y-axis holding portion 24a toward the case 21, the Y-axis movable member 24 is moved in the same manner. Further, the Y-axis movable member 25 may be moved relative to the case 21 in the same manner. This allows the distance between the Y-axis holding portions 24a and 25a to be adjusted in conformance with the length of the portable terminal 50.

In the same manner as the Y-axis holding portions 24a and 25a, a force that is greater than or equal to a predetermined value may be applied to the X-axis holding portions 22a and 23a to adjust the distance between the X-axis holding portions 22a and 23a in conformance with the width of the portable terminal 50.

Adjustment in the positions of the movable members 22 to 25 allows for the holder 20 to hold the portable terminal 50. When the portable terminal 50 is held by the holder 20, the portable terminal 50 is arranged on the front plate 21a of the case 21, with the X-axis holding portion 22a in planar contact with the left side surface 50b of the portable terminal 50, the X-axis holding portion 23a in planar contact with the right side surface 50d of the portable terminal 50, the Y-axis holding portion 24a in planar contact with the upper side surface 50a of the portable terminal 50, and the Y-axis holding portion 25a in planar contact with the lower side surface 50c of the portable terminal 50. The movable members 22 to 25 do not move when the applied force is less than the predetermined value. This prevents the movable members 22 to 25 from being moved by inertial force or the like when the vehicle is travelling.

The location where the secondary coil L2 is arranged in the portable terminal 50 differs depending on the type of the portable terminal 50. However, the holder 20 allows for the secondary coil L2 to be aligned with the primary coil L1.

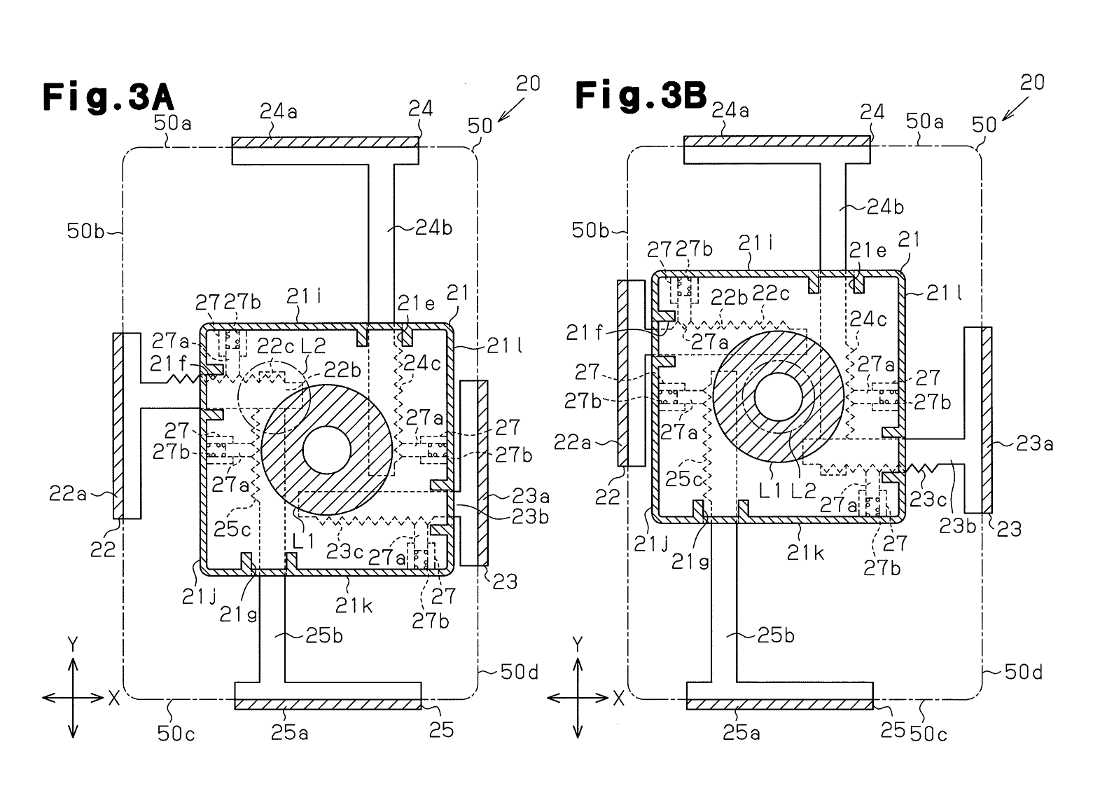

The procedures for positioning the primary coil L1 of the holder 20 will now be described with reference to FIGS. 3A and 3B.

As shown by the circle formed by the double-dashed line in FIG. 3A, the secondary coil L2 may be separated from the primary coil L1. In such a case, the separation of the two coils L1 and L2 lowers the power transmission efficiency. This is not a preferable situation. Thus, for alignment with the primary coil L1 in the Y-axis direction, the user applies force that is greater than or equal to the predetermined value to the case 21 in the upward direction, as viewed in the drawings, toward the Y-axis holding portion 24a. This moves the stopping piece 27a corresponding to the insertion portion 24b toward the Y-axis holding portion 24a along the stopped portion 24c. Thus, the stopping piece 27a corresponding to the insertion portion 24b is moved relative to the stopped portion 24c. Further, the stopping piece 27a corresponding to the insertion portion 25b is moved toward the distal end of the insertion portion 25b along the stopped portion 25c. Thus, the stopping piece 27a corresponding to the insertion portion 25b is moved relative to the stopped portion 25c. In the same manner as when moving the movable members 22 to 25, the elastic force of the springs 27b keeps the stopping pieces 27a engaged with the stopped portions 24c and 25c. In this manner, the case 21 is moved upward toward the Y-axis holding portion 24a so that the primary coil L1 is positioned in the Y-axis direction in conformance with the secondary coil L2.

For alignment with the primary coil L1 in the X-axis direction, the user applies force that is greater than or equal to the predetermined value to the case 21 in the leftward direction as viewed in the drawings toward the X-axis holding portion 22a. This moves the stopping piece 27a corresponding to the insertion portion 22b toward the X-axis holding portion 22a along the stopped portion 22c. Thus, the stopping piece 27a corresponding to the insertion portion 22b is moved relative to the stopped portion 22c. Further, the stopping piece 27a corresponding to the insertion portion 23b is moved toward the distal end of the insertion portion 23b along the stopped portion 23c. Thus, the stopping piece 27a corresponding to the insertion portion 23b is moved relative to the stopped portion 23c. The elastic force of the springs 27b keep the stopping pieces 27a engaged with the stopped portions 22c and 23c. In this manner, the case 21 is moved left toward the X-axis holding portion 22a so that the primary coil L1 is positioned in the X-axis direction in conformance with the secondary coil L2. Consequently, the two coils L1 and L2 are coaxially aligned. The holder 20 is kept in the condition adapted for the portable terminal 50 regardless of the setting and removal of the portable terminal 50 to and from the holder 20.

The predetermined value is set to be greater than the expected force applied to the holding portions 22a to 25a and the case 21 when the vehicle travels. Further, the predetermined value is set so that the user may easily apply force to the holding portions 22a to 25a and the case 21 with his or her hands.

The above embodiment has the advantages described below.

(1) The insertion portions 22b to 25b are inserted into the case 21 and movable relative to the case 21. The holding portions 22a to 25a are respectively formed on the ends (second ends) of the insertion portions 22b to 25b located outside the case 21. Thus, the insertion portions 22b to 25b allows for movement of the holding portions 22a to 25a relative to the case 21. Movement of the holding portions 22a to 25a relative to the case 21 allows for the distance between the holding portions 22a to 25a to be adjusted in conformance with the size of the portable terminal 50. As a result, the holding portions 22a to 25a hold the portable terminal 50 and prevent the portable terminal 50 from falling off from the holder 20.

Further, the case 21 is movable between the holding portions 22a to 25a relative to the portable terminal 50. This allows for the primary coil L1 in the case 21 to be aligned with the secondary coil of the portable terminal 50 and thereby obtains desirable power transmission efficiency.

(2) The stoppers 27 stop the movement of the movable members 22 to 25 with the insertion portions 22b to 25b. Thus, even under a situation in which inertial force or the like is applied to the holder 20 that holds the portable terminal 50, the holding portions 22a to 25a, which hold the portable terminal 50, do not move away from one another. This prevents the portable terminal 50 from falling off the holder 20. Further, the application of a force that is greater than or equal to the predetermined value to the holding portions 22a to 25a or the case 21 allows for movement of the movable members 22 to 25 relative to the case 21 even when the stoppers 27 stop movement of the movable members 22 to 25 with the insertion portions 22b to 25b.

(3) Movement of the portable terminal 50 in the X-axis direction is restricted by contact with the X-axis holding portions 22a and 23a, and movement of the portable terminal 50 in the Y-axis direction is restricted by contact with the Y-axis holding portions 24a and 25a. This ensures that the holder 20 holds the portable terminal 50.

(4) The user first adjusts the positions of the holding portions 22a to 25a in conformance with the size of the portable terminal 50, and then aligns the position of the primary coil L1 with the secondary coil L2 of the portable terminal 50. Then, the holder 20 is kept in the same condition regardless of the setting and removal of the portable terminal 50 to and from the holder 20. Thus, once the positioning is completed, the holding portions 22a to 25a and the primary coil L1 are located at positions suitable for the portable terminal 50. Subsequently, the user does not have to perform any adjustments and may just fit the portable terminal 50 to the holder 20.

(5) The movable members 22 to 25 are all movable relative to the case 21. This allows the case 21 to be moved without changing the distance between the X-axis holding portions 22a and 23a and the distance between the Y-axis holding portions 24a and 25a. This facilitates the positioning of the primary coil L1.

(6) The position of the primary coil L1 may be manually adjusted. This simplifies the structure of the wireless charging device 40 and lowers the manufacturing cost of the wireless charging device 40.

(7) The holder 20 allows for adjustment of the primary coil L1 and does not require more than one primary coil L1.

It should be apparent to those skilled in the art that the present invention may be embodied in many other specific forms without departing from the spirit or scope of the invention. Particularly, it should be understood that the present invention may be embodied in the following forms.

In the above embodiment, the stopped portions 22c to 25c may be omitted. In this case, for example, the stopping pieces 27a may be formed from rubber so that sufficient friction is produced between the stopping pieces 27a and the insertion portions 22b to 25b when the stopping pieces 27a contact the insertion portions 22b to 25b. The friction restricts movement of the movable members 22 to 25 when force that is less than the predetermined value is applied to the movable members 22 to 25.

In the above embodiment, the X-axis movable members 22 and 23 may be fixed to the case 21. In this case, the distance between the X-axis holding portions 22a and 23a is in conformance with the average size of the portable terminal 50 in the X-axis direction. In this structure, the position of the primary coil L1 in the Y-axis direction is adjusted to arrange the primary coil L1 near the secondary coil L2. This prevents drastic decreases in the power transmission efficiency. Alternatively, the Y-axis movable members 24 and 25 may be fixed to the case 21. In this case, the position of the primary coil L1 in the X-axis direction is adjusted to arrange the primary coil L1 near the secondary coil L2. These two structures further simplify the structure of the holder 20 as compared with the above embodiment.

One of the X-axis movable members 22 and 23 may be fixed to the case 21. In this case, the other one of the X-axis movable members 22 and 23 is movable relative to the case 21. This obtains the same advantages as the above embodiment.

One of the Y-axis movable members 24 and 25 may be fixed to the case 21. In this case, the other one of the Y-axis movable members 24 and 25 is movable relative to the case 21. This obtains the same advantages as the above embodiment.

The wireless charging device 40 does not have to be used in a vehicle like in the above embodiment. The function of the holder 20 for holding the portable terminal 50 is effective especially when the wireless charging device 40 is set at a location that is apt to being vibrated.

In the above embodiment, the spring 27b may be replaced by any elastic member that urges the stopping piece 27a, such as a rubber member.

In the above embodiment, the wireless charging device 40 is of a single coil type that includes the single primary coil L1. However, the wireless charging device 40 may include a plurality of primary coils L1. In this case, the primary coils L1 may be moved together with the case 21.

In the above embodiment, the primary coil L1 is a round spiral coil but may be a coil of any type and shape. The secondary coil L2 may also be a coil of any type and shape.

In the above embodiment, the insertion portions 22b to 25b are inserted into the case 21. Holding members may be arranged outside the case 21 to movably support the insertion portions 22b to 25b. The holding members form the case 21.

Technical concepts described below may be recognized from the forgoing description.

The holder according to the present invention may be used in a vehicle. When the vehicle is travelling, inertial force, centrifugal force, the running engine, and the road surface may vibrate the charged device. In such cases, the holder prevents the charged device from falling off.

The holder according to the present invention, wherein the stopper includes an elastic member and a stopping piece, which is urged toward the insertion portion by elastic force of the elastic member, the stopping piece comes into contact with an insertion portion where a stopped portion is formed by serrations, and the stopping piece is engaged with the a section of the stopped portion to stop movement of the insertion portion.

In this structure, the stopping piece, which is urged by the elastic member, is engaged with the stopped member to stop movement of the insertion portion and the holding portion. Further, the application of a force greater than or equal to a predetermined value moves the stopping piece along the insertion portion. The stopping piece expands and contracts the elastic member in conformance with the serrated form of the stopped portion. This allows for relative movement between the insertion portion and the case when necessary.

The present examples and embodiments are to be considered as illustrative and not restrictive, and the invention is not to be limited to the details given herein, but may be modified within the scope and equivalence of the appended claims.

1. A holder for holding a charged device, wherein the charged device includes a secondary coil that induces power based on a change in magnetic flux from a primary coil, the holder comprising:
a case that accommodates the primary coil;
a plurality of movable portions movably held by the case, wherein the movable portions are movable relative to the case, and each of the movable portions includes a first end located in the case and a second end located outside the case; and
a plurality of holding portions, each formed on the second end of each of the movable portions, wherein the holding portions contact side surfaces of the charged device to surround and hold the charged device.

2. The holder according to claim 1, further comprising at least one stopper that stops movement of at least one of the movable portions in the case, and allows for the holding portion corresponding to the at least one movable portions to move relative to the case when force of a predetermined value or greater is applied to the holding portion or the case.

3. The holder according to claim 1, wherein
the charged device includes two parallel first side surfaces, which extend in a first direction, and two parallel second side surfaces, which extend in a second direction that is orthogonal to the first direction; and
the holding portions include
two first holding portions that move along the first direction and respectively contact the two second side surfaces, and
two second holding portions that move along the second direction and respectively contact the two first side surfaces.

4. A wireless charging device for charging a charged device including a secondary coil, the wireless charging device comprising:
an excitation circuit;
a primary coil that forms magnetic flux when excited by current from the excitation circuit to induce power at the secondary coil; and
a holder that holds the charged device, wherein the holder includes
a case that accommodates the primary coil,
a plurality of movable portions movably held by the case, wherein the movable portions are movable relative to the case, and each of the movable portions includes a first end located in the case and a second end located outside the case, and
a plurality of holding portions, each formed on the second end of each of the movable portions, wherein the holding portions contact side surfaces of the charged device to surround and hold the charged device.

5. The wireless charging device according to claim 4, wherein the holder further includes at least one stopper that stops movement of at least one of the movable portions in the case, and allows for the holding portion corresponding to the at least one movable portions to move relative to the case when force of a predetermined value or greater is applied to the holding portion or the case.

6. The wireless charging device according to claim 4, wherein
the charged device includes two parallel first side surfaces, which extend in a first direction, and two parallel second side surfaces, which extend in a second direction that is orthogonal to the first direction; and
the holding portions include
two first holding portions that move along the first direction and respectively contact the two second side surfaces, and
two second holding portions that move along the second direction and respectively contact the two first side surfaces.
